(19) United States
(12) Patent Application Publication
(10) Pub. No.: US 2026/0129551 A1
(43) Pub. Date: May 7, 2026

(54) SYSTEMS AND METHODS FOR INFORMATION TRANSFER IN IAB SYSTEM AND APPARATUS

(71) Applicant: ZTE CORPORATION, Shenzhen, Guangdong (CN)

(72) Inventors: Ying HUANG, Shenzhen (CN); Lin CHEN, Shenzhen (CN)

(21) Appl. No.: 19/115,917

(22) PCT Filed: Sep. 28, 2022
(86) PCT No.: PCT/CN2022/122001

§ 371 Date: Mar. 27, 2025

(51) Int. Cl. H04W 40/22; H04W 88/08

(52) U.S. Cl. CPC H04W 40/22; H04W 88/085

(57) ABSTRACT

Presented are systems, methods, apparatuses, or computer-readable media for information transfer in integrated access and backhaul (IAB) system and apparatus. A first network node may receive a first message including F1 control plane (F1-C) related traffic from a network function. The first network node can send a second message comprising the F1-C related traffic to a second network node.

### TECHNICAL FIELD

The disclosure relates generally to wireless communications, including but not limited to systems and methods for information transfer in integrated access and backhaul (IAB) system and apparatus.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, a method, an apparatus, or a computer-readable medium for transferring information in an IAB system. A first network node (e.g., target donor) can receive/obtain/collect/acquire a first message/information/signal from a network function (e.g., access and mobility management function (AMF)). The first message can include F1 control plane (F1-C) related traffic. The first network node can send/transmit/provide/signal/communicate a second message to a second network node (e.g., mobile-IAB node). The second message can comprises the F1-C related traffic.

In various arrangements, the network function can receive a message including the F1-C related traffic from a third network node (e.g., source donor). In some implementations, at least one of: the message can be a new generation application protocol (NGAP) message, the message can include destination information, and/or the third network node can receive the destination information from the first network node or the network function.

In some arrangements, at least one of: the message can be a user equipment (UE) associated message that is associated with the second network node, and/or the message can include at least one of: AMF UE new generation application protocol (NGAP) identifier (ID) and/or a radio access network (RAN) UE NGAP ID. In certain implementations, at least one of: the first message can be a NGAP message, and/or the first message can include destination information.

In some aspects, at least one of: the second message can be a radio resource control (RRC) message, and/or the second message includes destination information. In some cases, a mobile termination (MT) of the second network node may send the F1-C related traffic, from the second message, to a distributed unit (DU) of the second network node. In some arrangements, at least one of: the second message can be an F1AP message, and/or the second message can include destination information.

In some implementations, a first DU of the second network node can send the F1-C related traffic, from the second message, to another DU of the second network node. In some arrangements, the destination information can comprise at least one of: a DU identity, a backhaul adaptation protocol (BAP) address, a centralized unit (CU) identity, a next generation NodeB (gNB) identity (e.g., base station (BS) or wireless communication node), a source logical DU indication, a logical DU identity, and/or an internet protocol (IP) address.

At least one aspect is directed to a system, a method, an apparatus, or a computer-readable medium for transferring information in an IAB system. A network function (e.g., AMF) can send a first message to a first network node (e.g., target donor). The first message can include F1 control plane (F1-C) related traffic. The first network node can send a second message to a second network node (e.g., mobile-IAB node). The second message can comprise the F1-C related traffic.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates a block diagram of an environment for a mobile integrated access and backhaul (IAB), in accordance with an illustrative embodiment;

FIG. 4A illustrates a block diagram of an integrated access and backhaul (IAB) architecture using standalone (SA) mode with a next generation core (NGC), in accordance with an illustrative embodiment;

FIG. 4B illustrates a block diagram of an integrated access and backhaul (IAB) architecture using Evolved Universal Mobile Telecommunications System New Radio (EN-DC), in accordance with an illustrative embodiment;

FIG. 5 illustrates a block diagram of integrated access and backhaul (IAB) nodes in a parent and child relationship, in accordance with an illustrative embodiment;

FIG. 6 illustrates a block diagram of an integrated access and backhaul (IAB) mobile termination (MT) migrating from a first donor centralized unit (CU1) to a second donor centrailized unit (CU2), in accordance with an illustrative embodiment; and

FIG. 7 illustrates of a flow diagram of a method for transferring information in an IAB system, in accordance with an illustrative embodiment.

### DETAILED DESCRIPTION

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 1. Mobile Communication Technology and Environment

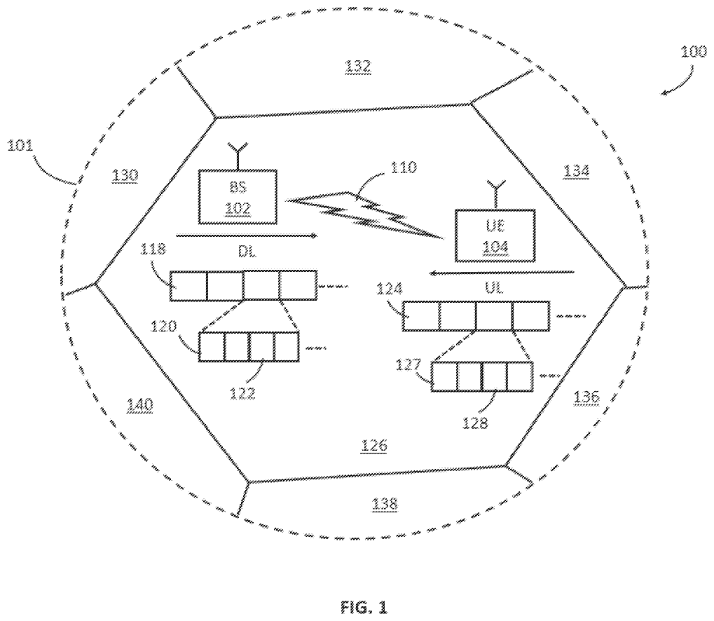

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

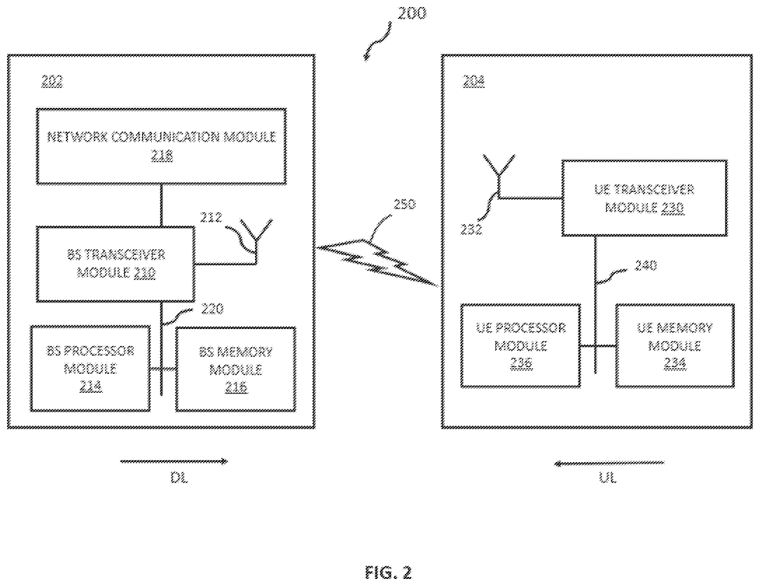

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuity that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

### 2. Systems and Methods for Transferring Information in an IAB System

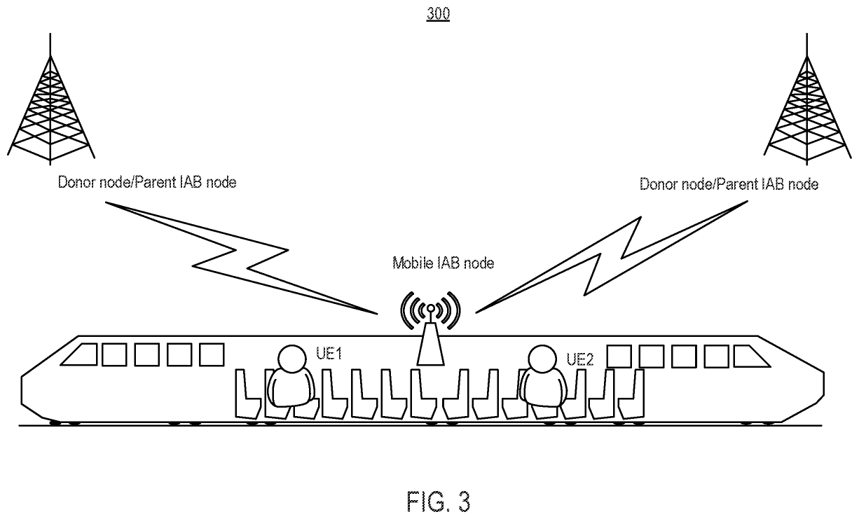

Referring now to FIG. 3, depicted is a block diagram 300 of an environment for a mobile integrated access and backhaul (IAB). An Integrated Access and Backhaul (IAB) may support wireless backhauling via new radio (NR) enabling flexible and very dense deployment of NR cells while reducing the need for wireline transport infrastructure. Intra-donor centralized unit (CU) migration procedure may be provided in which both the source and the target parent node are served by the same IAB-donor-CU. The inter-donor CU migration in the migrating (mobile) IAB node, however, may be static. It may be difficult to perform inter-donor migration in a mobile IAB use scenario as depicted. In a mobile IAB use case, IAB nodes are mounted in vehicles and can provide coverage and capacity enhancement to onboard or surrounding user equipment (UEs). In certain scenarios, there may be no IP connectivity between two donors (e.g., between a source donor CU and a target donor DU), or no Xn connection between two donors (e.g., source donor CU and target donor CU). Hence, the systems and methods of the technical solution can perform the features, functionalities, or operations discussed herein to perform inter-donor migration when there is an absence of IP connectivity between, for instance, source donor CU and target donor DU, and/or an absence of Xn connection between source and target donor CUs.

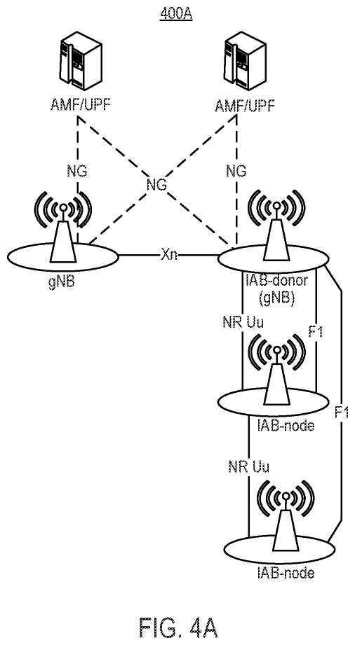

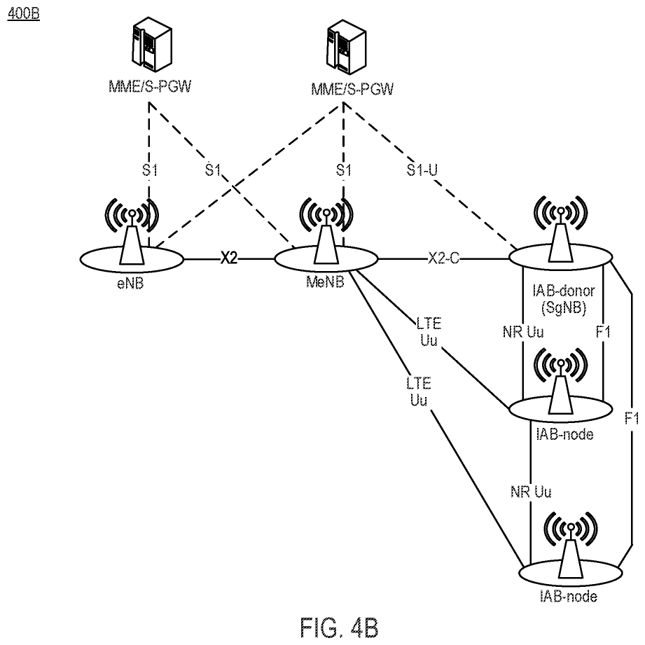

Referring now to FIG. 4A, depicted is a block diagram 400A of an integrated access and backhaul (IAB) architecture using standalone (SA) mode with a next generation core (NGC). The integrated access and backhaul (IAB) can enable wireless relaying in NG-RAN. The relaying node, referred to as IAB node, may support access and backhauling via NR. The terminating node of NR backhauling on network side may be referred to as the IAB-donor, which can represent a gNB with additional functionality to support IAB. Backhauling can occur via a single or via multiple hops.

The IAB node may support gNB-DU functionality, to terminate the NR access interface to UEs and next-hop IAB nodes, and/or to terminate the F1 protocol to the gNB-CU functionality, on the IAB-donor. The gNB-DU functionality on the IAB node may be also referred to as IAB distributed unit (DU) (IAB-DU). In addition to the gNB-DU functionality, the IAB node may also support a subset of the UE functionality referred to as IAB-mobile termination (MT), which can include, e.g., physical layer, layer-2, radio resource control (RRC) and non-access stratum (NAS) functionality to connect to the gNB-DU of another IAB node or the IAB-donor, to connect to the gNB-CU on the IAB-donor, and to the core network, among others.

Referring now to FIG. 4B, depicted is a block diagram 400B of an integrated access and backhaul (IAB) architecture using Evolved Universal Mobile Telecommunications System New Radio (EN-DC). The IAB node can access the network using either SA-mode or EN-DC. In EN-DC, the IAB node also connects via E-UTRA to a MeNB, and the IAB-donor terminates X2-C as SgNB (e.g., as defined in TS 37.340).

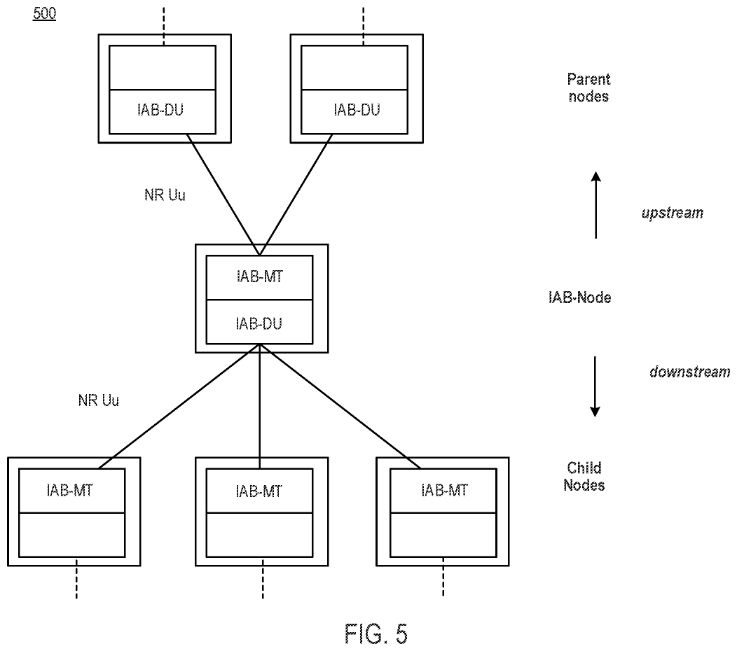

Referring now to FIG. 5, depicted is a block diagram 500 of integrated access and backhaul (IAB) nodes in a parent and child relationship. All IAB nodes that are connected to an IAB-donor via one or multiple hops can form a directed acyclic graph (DAG) topology with the IAB-donor at its root. In this DAG topology, the neighbor node on the IAB-DU's interface may be referred to as child node and the neighbor node on the IAB-MT's interface is referred to as parent node. The direction toward the child node may be further referred to as downstream while the direction toward the parent node is referred to as upstream. The IAB-donor may perform centralized resource, topology and route management for the IAB topology.

In various arrangements, the terminology discussed herein can be provided or described as follows. IAB-donor can refer to or correspond to a gNB (e.g., BS 102, wireless communication node, or network node) that provides network access to UEs 104 via a network of backhaul and access links. IAB-donor-CU can refer to the gNB-CU of an IAB-donor, terminating the F1 interface towards IAB-nodes and IAB-donor-DU. IAB-donor-DU can refer to the gNB-DU of an IAB-donor, hosting the IAB BAP sublayer (e.g., as defined in TS 38.340), and providing wireless backhaul to IAB nodes. IAB-DU can refer to gNB-DU functionality supported by the IAB-node to terminate the NR access interface to UEs 104 and next-hop IAB-nodes, and to terminate the F1 protocol to the gNB-CU functionality (e.g., as defined in TS 38.401) on the IAB-donor. IAB-MT can refer to IAB node function that terminates the Uu interface to the parent node using the procedures and behaviours specified for UEs 104 (e.g., unless configured/set/stated otherwise). In some cases, the IAB-MT function may correspond to IAB-UE function (e.g., defined in TS 23.501). IAB-node can refer to RAN node that supports NR access links to UEs 104 and NR backhaul links to parent nodes and child nodes. The IAB node may or may not support backhauling via LTE. A child node can correspond to the next hop neighbor node of at least one of the IAB-DU and/or IAB-donor-DU. The child node can also be an IAB node. A parent node can refer to the next hop neighbor node of IAB-MT. The parent node can be IAB-node or IAB-donor-DU. Upstream can refer to the direction toward the parent node in IAB-topology. Downstream can refer to the direction toward the child node and/or the UE 104 in IAB-topology.

In some scenarios, IAB-MT, IAB-DU, and the served UEs 104 may be migrated to the target donor for inter-donor full migration of the IAB node. If UE migration is performed after MT migration, F1-C related traffic (e.g., sometimes referred to generally as F1-C traffic information) containing/including the RRC reconfiguration message for the UE 104 may be transmitted from source donor CU to mobile IAB-DU through the target donor DU. However, in these scenarios, there may be no IP connection communicated/transmitted/exchanged between the source donor CU and the target donor DU, and/or no Xn connection between the source and target donor CUs. Hence, the systems and methods of the technical solution discussed herein can perform F1-C related traffic transmission/transfer between the source donor CU and the mobile IAB-DU via the target donor DU in scenarios where there is no IP connectivity/connection and/or Xn connection between the source and target donors (e.g., source donor CU and target donor DU when no IP connection and/or source and target donor CUs when no Xn connection). The F1-C related traffic transfer can be performed via 5GC.

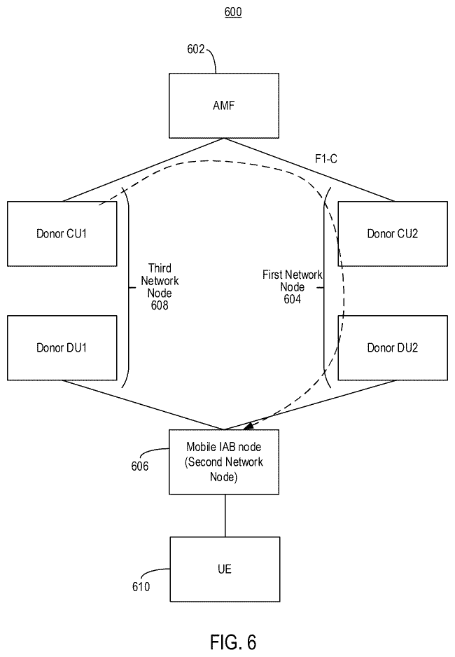

Referring to FIG. 6, depicted is a block diagram 600 of an integrated access and backhaul (IAB) node 606 (e.g., sometimes referred to as a second network node) migrating from a first donor centralized unit (CU1) (e.g., sometimes referred to as a third network node or a source donor node 608) to a second donor centralized unit (CU2) (e.g., sometimes referred to as a first network node or a target donor node 604). As depicted, the (e.g., mobile) IAB node 606 may migrate from donor DU1 (e.g., belonging to donor CU1 or the source donor 608) to donor DU2 (e.g., belonging to donor CU2 or the target donor 604). After the migration of the IAB node 606 (e.g., mobile IAB-MT), the IAB node 606 can disconnect with the source donor 608 (e.g., donor DU1/CU1). Subsequently, the source donor (e.g., donor CU1) can transmit/send/provide the F1-C message/traffic/signal containing RRC reconfiguration message of the UE 610 (e.g., UE 104) via the target donor 604 (e.g., donor DU2) through an access and mobility management function (AMF) 602.

In various aspects, operations/steps/procedures can be described herein for transferring the information (e.g., F1-C related traffic) in the IAB system without an IP connection and/or Xn connection between the source donor 608 and the target donor 604, such as for inter-donor migration. In addition to implementation 1 and implementation 2 described, other arrangements and/or combinations of the techniques/operations described in implementations 1-2 can be included as part of the technical solution herein for information transfer and inter-donor migration without IP and/or Xn connections.

### Implementation 1

Step 1: the source donor 608 (e.g., donor CU1) can send/transmit/provide a new generation application protocol (NGAP) message (e.g., sometimes referred to generally as a message) to the AMF 602 (e.g., network function). The NGAP message can include/contain F1-C related traffic, such as F1-C-related packets contained as a container.

In some implementations, the NGAP message may include destination information. The destination information may be used to determine which node (e.g., donor node) the NGAP message should be transmitted to. Additionally or alternatively, the destination information may be used to determine which node the F1-C related traffic in the NGAP message should be transmitted to. For instance, a first destination information can include at least one of: DU identity (e.g., DU in mobile IAB node 606), backhaul adaptation protocol (BAP) address (e.g., of mobile IAB node 606), CU identity (e.g., of donor CU2 or the target donor 604), gNB/BS 102/wireless communication node identity (ID) (e.g., of donor CU2), source logical DU indication (e.g., of DU in mobile IAB node 606), logical DU identity (e.g., of DU in mobile IAB node 606).

In some cases, source donor 608 (e.g., donor CU1) may receive the destination information from the target donor 604 (e.g., donor CU2) and/or the AMF 602 prior to or before sending the NGAP message. In certain implementations, the NGAP message (e.g., transmitted by the source donor 608) may be a UE-associated message that is associated with the IAB node 606 (e.g., mobile IAB-MT). In this case, the NGAP message may include at least one of an AMF UE NGAP ID and/or RAN UE NGAP ID, for example.

Step 2: after receiving the message from the source donor 608, the AMF 602 can send a NGAP message (e.g., a first message) to the target donor 604 (e.g., donor CU2). The NGAP message can include the F1-C related traffic, e.g., F1-C related packets. In some implementations, the NGAP message can include destination information (e.g., sometimes referred to as first destination information). The destination information can include at least one of DU identity, BAP address, CU identity, gNB identity, source logical DU indication, and/or logical DU identity, among others.

In some cases, the NGAP message may be UE associated message that is associated with the IAB node 606 (e.g., mobile IAB-MT). In this case, the NGAP message can include at least one of AMF UE NGAP ID and/or RAN UE NGAP ID.

Step 3: the target donor 604 can receive the NGAP message (e.g., first message) from the AMF 602. Subsequently, the target donor 604 (e.g., donor CU2) can transmit/send/signal an RRC message (e.g., a second message) to the IAB node 606 (e.g., mobile IAB-MT). The RRC message may include/contain F1-C related traffic, e.g., F1-C related packets. In some cases, the RRC message can include destination information (e.g., sometimes referred to as second destination information). The second destination information can include similar and/or different information from the first destination information. The destination information may be used to determine which node the F1-C related traffic in the RRC message should be transmitted to (e.g., the node to receive the F1-C related traffic or the node configured as the destination/target for transmission of the F1-C related traffic). For instance, the second destination information can include at least one of DU identity, BAP address (e.g., mobile IAB node 606), source logical DU indication, and/or logical DU identity, etc. In some cases, the destination information (e.g., first and/or second destination information) may include an IP address. The IP address included in the destination information can be associated with the sender/transmitter and/or receiver (e.g., source donor 608, target donor 604, IAB node 606, and/or AMF 602), among others.

Step 4: the RRC message received by the IAB-MT can include F1-C related traffic. The F1-C related traffic may be sent by the source donor CU, for instance, to the DU connected with the source donor CU (e.g., sometimes referred to as source logical DU in the mobile IAB node 606). The IAB node 606 (e.g., mobile IAB-MT) can deliver/send/transmit the F1-C related traffic contained/included in the RRC message to a co-located IAB-DU (e.g., in mobile IAB node 606), such as source logical DU. Accordingly, information (e.g., F1-C related traffic) can be transferred/transmitted from the source donor to the target donor for inter-donor migration without IP connectivity or Xn connection between the source and target donors.

### Implementation 2

Steps 1 and 2 of implementation 2 can be performed similarly to steps 1 and 2 as described in conjunction with implementation 1.

Step 3: after the target donor 604 can receive the NGAP message donor from the AMF 602 (e.g., continuing from step 2 of implementation 1), the target donor 604 (e.g., donor CU2) can send an F1AP message (e.g., a second message) to IAB node 606 (e.g., mobile IAB-DU, such as target logical DU. The F1AP message can include/contain F1-C related traffic, e.g., F1-C related packets contained as a container.

In some implementations, the F1AP message can include destination information (e.g., second destination information). The second destination information may include similar and/or different information from the first destination information, such as described in conjunction with step 2, for example. The (e.g., second) destination information can include at least one of DU identity, BAP address, source logical DU indication, and/or logical DU identity. In some cases, the destination information may include an IP address. For instance, the IP address may be associated with the sender/transmitter and/or receiver (e.g., source donor 608, target donor 604, IAB node 606, and/or AMF 602), among others.

Step 4: the IAB node 606 can receive the second message (e.g., F1AP message) from the target donor 604. The second message can be received by the IAB-DU connected with the target donor. The second message can include F1-C related traffic. The F1-C related traffic may be sent by the source donor CU, for instance, to the DU connected with the source donor CU (e.g., sometimes referred to as source logical DU in the mobile IAB node 606). The IAB node 606 (e.g., mobile IAB-DU, such as target logical DU or first DU) can deliver/provide the F1-C related traffic contained in the F1AP message to the other logical DU in the mobile IAB node 606, e.g., source logical DU (e.g., another DU of the IAB node 606). Hence, similar to implementation 1, the technical solution can enable the transfer of information between donors for inter-donor migration without IP connectivity or Xn connection between the donors.

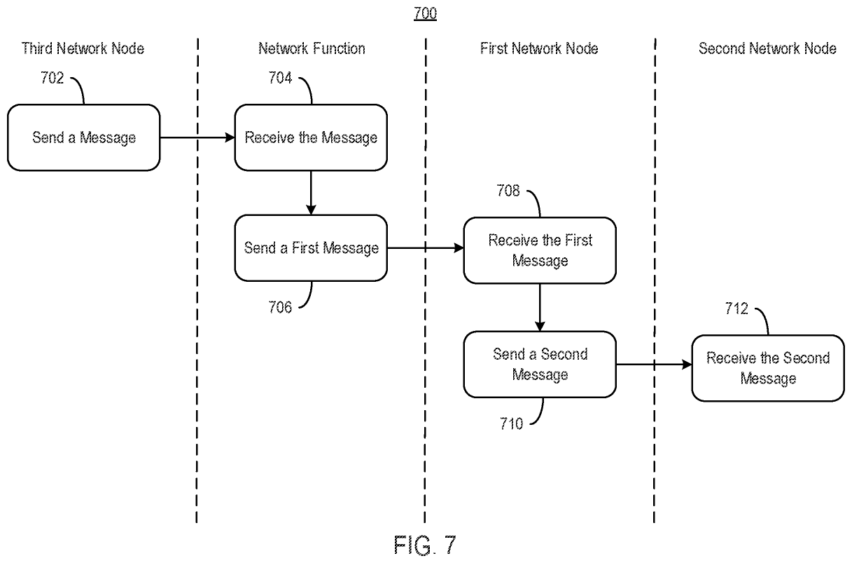

Referring now to FIG. 7, depicted is a flow diagram of a method 700 for transferring information in an IAB system. The method 700 may be implemented using or performed by any of the components detailed above, such as the UE 104 or 204, BS 102 or 202, AMF 602, various donors 604, 608, and/or mobile IAB node 606, among others. In overview, a third network node can send a message (702). A network function can receive the message (704). The network function can send a first message (706). A first network node can receive the first message (708). The first network node can send a second message (710). A second network node can receive the second message (712).

In further detail, a third network node (e.g., source donor or source CU) can send/transmit/provide a message to a network function (e.g., AMF) (702). The network function can receive/obtain/acquire the message from the third network node (704). The message transmitted from the third network node may include F1-C related traffic.

In various arrangements, at least one of: the message may be a new generation application protocol (NGAP) message, the message may include destination information, and/or the third network node may receive/obtain destination information from a first network node (e.g., target donor or donor CU2) and/or the network function. In some implementations, at least one of: the message may be a UE (e.g., wireless communication device) associated message that is associated with a second network node (e.g., mobile IAB node), and/or the message can include at least one of: an AMF UE NGAP ID and/or a RAN UE NGAP ID.

After receiving the message from the third network node, the network function can send a first message (e.g., NGAP message) to the first network node (e.g., target donor or donor CU2) (706). The first network node can receive the first message from the network function (708). The first message can include F1 control plane (F1-C) related traffic. In various arrangements, at least one of: the first message may be a NGAP message and/or the first message may include destination information.

In response to receiving the first message, the first network node can send a second message (e.g., RRC message or F1AP message) to the second network node (e.g., mobile IAB node, such as mobile IAB-MT or mobile IAB-DU) (710). The second message can include the F1-C related traffic. Accordingly, the second network node can receive the second message from the first network node (712).

In some implementations, at least one of the second message can be an RRC message and/or the second message can include destination information. The destination information (e.g., second destination information) of the second message may include similar or different information from the destination of the first message (e.g., first destination information). In various arrangements, a mobile termination (MT) of the second network node may send the F1-C related traffic, from the second message, to a distributed unit (DU) (e.g., co-located IAB-DU) of the second network node. In these arrangements, the techniques or operations may be performed similar to the operations described in implementation 1, for example.

In certain implementations, at least one of the second message may be an F1 application protocol (F1AP) message and/or the second message may include destination information. In some arrangements, a first DU (e.g., target logical DU) of the second network node may send the F1-C related traffic, from the second message, to another DU (e.g., source logical DU) of the second network node. In these arrangements, the techniques or operations may be performed similar to the operations described in implementation 2, for example.

In various arrangements, the destination information comprises at least one of: a distributed unit (DU) identity, a backhaul adaptation protocol (BAP) address (e.g., used to identify the second network node), a centralized unit (CU) identity, a next generation NodeB (gNB) identity, a source logical DU indication, a logical DU identity, and/or an internet protocol (IP) address, among others. The destination information can be included as part of at least one of the first message, the second message, and/or the message (e.g., from the third network node), for example.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method, comprising:
receiving, by a first network node from a network function, a first message including F1 control plane (F1-C) related traffic; and
sending, by the first network node to a second network node, a second message comprising the F1-C related traffic.

2. The method of claim 1, wherein the network function receives a message including the F1-C related traffic from a third network node.

3. The method of claim 2, wherein at least one of:
the message is a new generation application protocol (NGAP) message,
the message includes destination information, or
the third network node receives the destination information from the first network node or the network function.

4. The method of claim 2, wherein at least one of:
the message is a user equipment (UE) associated message that is associated with the second network node, or
the message includes at least one of: an access and mobility management function (AMF) user equipment (UE) new generation application protocol (NGAP) identifier (ID) or a radio access network (RAN) UE NGAP ID.

5. The method of claim 1, wherein at least one of:
the first message is a new generation application protocol (NGAP) message, or
the first message includes destination information.

6. The method of claim 1, wherein at least one of:
the second message is a radio resource control (RRC) message, or
the second message includes destination information.

7. The method of claim 1, wherein a mobile termination (MT) of the second network node sends the F1-C related traffic, from the second message, to a distributed unit (DU) of the second network node.

8. The method of claim 1, wherein at least one of:
the second message is an F1 application protocol (F1AP) message, or
the second message includes destination information.

9. The method of claim 1, wherein a first distributed unit (DU) of the second network node sends the F1-C related traffic, from the second message, to another DU of the second network node.

10. The method of claim 3, wherein the destination information comprises at least one of:
a distributed unit (DU) identity,
a backhaul adaptation protocol (BAP) address,
a centralized unit (CU) identity,
a next generation NodeB (gNB) identity,
a source logical DU indication,
a logical DU identity, or
an internet protocol (IP) address.

11. A method, comprising:
sending, by a network function to a first network node, a first message including F1 control plane (F1-C) related traffic,
wherein the first network node sends to a second network node, a second message comprising the F1-C related traffic.

12. A non-transitory computer readable storage medium storing instructions, which when executed by one or more processors can cause the one or more processors to perform the method of claim 1.

13. A device comprising at least one processor configured to implement the method of claim 1.

14. The method of claim 11, wherein the network function receives a message including the F1-C related traffic from a third network node.

15. The method of claim 14, wherein at least one of:
the message is a new generation application protocol (NGAP) message,
the message includes destination information, or
the third network node receives the destination information from the first network node or the network function.

16. The method of claim 14, wherein at least one of:
the message is a user equipment (UE) associated message that is associated with the second network node, or
the message includes at least one of: an access and mobility management function (AMF) user equipment (UE) new generation application protocol (NGAP) identifier (ID) or a radio access network (RAN) UE NGAP ID.

17. The method of claim 11, wherein at least one of:
the first message is a new generation application protocol (NGAP) message, or
the first message includes destination information.

18. The method of claim 11, wherein at least one of:
the second message is a radio resource control (RRC) message, or
the second message includes destination information.

19. A non-transitory computer readable storage medium storing instructions, which
when executed by one or more processors can cause the one or more processors to perform the method of claim 11.

20. A device comprising at least one processor configured to implement the method of claim 11.
